(19) United States
(12) Patent Application Publication
(10) Pub. No.: US 2007/0252807 A1
(43) Pub. Date: Nov. 1, 2007

(54) Pulse driving circuit

(75) Inventors: Jian-Hui Lu, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/796,881

(22) Filed: Apr. 30, 2007

(30) Foreign Application Priority Data
Apr. 28, 2006 (TW) 95115275

(51) Int. Cl. G09G 3/36

(52) U.S. Cl. 345/102

(57) ABSTRACT

An exemplary pulse driving circuit (200) includes a pulse generator (210) configured for generating a pulse signal for driving the pulse driving circuit; a capacitor (220); an NMOS (negative metal-oxide semiconductor) transistor (230) comprising a gate electrode configured to be connected to the pulse generator via the capacitor, a drain electrode configured to be connected to a load circuit, and a source electrode configured to be connected to a DC (direct current) power supply (270); a current limiting resistor (240) connected between the gate electrode and the source electrode of the NMOS transistor; and a diode (250) comprising a positive terminal connected to the source electrode of the NMOS transistor and a negative terminal connected to the gate electrode of the NMOS transistor.

### FIELD OF THE INVENTION

The present invention relates to pulse driving circuit which can be used in liquid crystal displays (LCDs), and particularly to a pulse driving circuit having an NMOS (negative metal-oxide semiconductor) transistor.

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

A typical LCD includes an LCD panel, a backlight for illuminating the LCD panel, and a backlight control circuit for controlling the backlight. The backlight control circuit includes a pulse width modulation integrated circuit (PWM IC) configured for generating pulse signals, and an inverter circuit. The inverter circuit includes a coil and a pulse driving circuit. The pulse driving circuit is configured for receiving the pulse signals and driving the coil according to relative duty ratios of the pulse signals. Thus the inverter circuit can transform a low direct current (DC) voltage to a high alternating current (AC) voltage for driving the backlight. The backlight can include one or more lamps, such as cold cathode fluorescent lamps.

FIG. 2 is a diagram of a typical pulse driving circuit used in an inverter of an LCD. The pulse driving circuit 100 includes a pulse generator 110, an NMOS (negative metal-oxide semiconductor) transistor 120, a PMOS (positive metal-oxide semiconductor) transistor 130, a current limiting resistor 140, an NPN (negative-positive-negative) type transistor 150, a PNP (positive-negative-positive) type transistor 151, a load circuit 160, and a twelve volt DC (direct current) power supply 170. The pulse generator 110 can be a PWM IC, which is configured for generating a pulse signal. A width of the pulse signal generated by the pulse generator 110 is in the range from 0˜5 volts. A frequency of the pulse signal generated by the generator 110 is approximately equal to fifty-two thousand hertz. The load circuit 160 is a coil of a transformer.

A drain electrode “D” of the PMOS transistor 130 is connected to the load circuit 160. A source electrode “S” of the PMOS transistor 130 is connected to the DC power supply 170.

A gate electrode “G” of the NMOS transistor 120 is connected to the pulse generator 110. A source electrode “S” of the NMOS transistor 120 is connected to ground. A drain electrode “D” of the NMOS transistor 120 is connected to the DC power supply 170 via the current limiting resistor 140.

Base electrodes “b” of the NPN type transistor 150 and the PNP type transistor 151 are connected to the drain electrode “D” of the NMOS transistor 120. Emitter electrodes “e” of the NPN type transistor 150 and the PNP type transistor 151 are connected to the gate electrode “G” of the PMOS transistor 130. A collecter electrode “c” of the NPN type transistor 150 is connected to the DC power supply 170. A collecter electrode “c” of the PNP type transistor 151 is connected to ground. The NPN type transistor 150 and the PNP type transistor 151 cooperatively function as a step-up circuit.

When a plus five volts voltage generated by the pulse generator 110 is provided to the gate electrode “G” of the NMOS transistor 120, the NOMS transistor 120 is turned on. Accordingly, the base electrodes “b” of the NPN type transistor 150 and the PNP type transistor 151 are connected to ground via the activated NOMS transistor 120. Therefore, the NPN type transistor 150 is turned off, and the PNP type transistor 151 is turned on. Thus the gate electrode “G” of the PMOS transistor 130 is connected to ground via the activated PNP type transistor 151. Because a potential between the gate electrode “G” and the source electrode “S” of the PMOS transistor 130 is approximately equal to minus twelve volts, the PMOS transistor 130 is turned on.

When a zero volts voltage generated by the pulse generator 110 is provided to the gate electrode “G” of the NMOS transistor 120, the NOMS transistor 120 is turned off. Accordingly, the base electrodes “b” of the NPN type transistor 150 and the PNP type transistor 151 are connected to the DC power supply 170 via the current limiting resistor 140. Therefore, the NPN type transistor 150 is turned on, and the PNP type transistor 151 is turned off. Thus the gate electrode “G” of the PMOS transistor 130 is connected to the DC power supply 170 via the activated NPN type transistor 150. Because a potential between the gate electrode “G” and the source electrode “S” of the PMOS transistor 130 is approximately equal to zero volts, the PMOS transistor 130 is turned off.

Because the frequency of the pulse signal generated by the pulse generator 110 is approximately equal to fifty-two thousand hertz, the DC power supply 170 drives the load circuit 160 via the PMOS transistor 130 with a switching frequency which is approximately equal to fifty-two thousand hertz. Thus an inverter (not shown) having the pulse driving circuit 100 can generate a high alternating current (AC) for driving a backlight of an LCD. However, the pulse driving circuit 100 requires the four transistors 120, 130, 150, 151, which means the cost of the pulse driving circuit 100 is relatively high.

It is desired to provide a new pulse driving circuit used in an inverter of an LCD which can overcome the above-described deficiencies.

### SUMMARY

In one preferred embodiment, a pulse driving circuit includes: a pulse generator configured for generating a pulse signal for driving the pulse driving circuit; a capacitor; an NMOS transistor comprising a gate electrode connected to the pulse generator via the capacitor, a drain electrode configured to be connected to a load circuit, and a source electrode configured to be connected to a DC power supply; a current limiting resistor connected between the gate electrode and the source electrode of the NMOS transistor; and a diode comprising a positive terminal connected to the source electrode of the NMOS transistor and a negative terminal connected to the gate electrode of the NMOS transistor.

Other novel features and advantages of the pulse driving circuit will become more apparent from the following detailed description when taken in conjunction with the accompanying drawings.

### BRIEF DESCRIPTION OF THE DRAWINGS

FIG. 1 is a diagram of a pulse driving circuit according to an exemplary embodiment of the present invention, the pulse driving circuit being typically used in an inverter of an LCD.

FIG. 2 is a diagram of a conventional pulse driving circuit used in an inverter of an LCD.

### DETAILED DESCRIPTION OF PREFERRED EMBODIMENTS

Reference will now be made to the drawings to describe various embodiments of the present invention in detail.

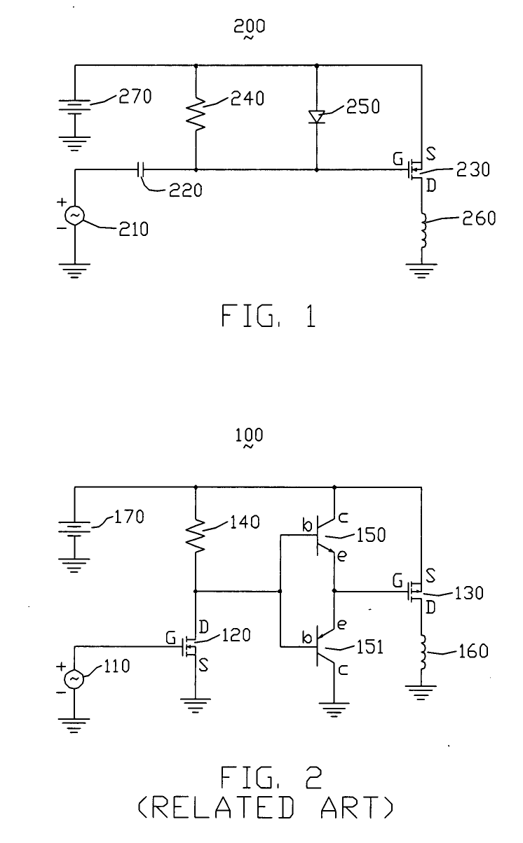

FIG. 1 is a diagram of a pulse driving circuit according to an exemplary embodiment of the present invention, the pulse driving circuit being typically used in an inverter of an LCD. The LCD typically also includes an LCD panel and a backlight. The backlight can include one or more lamps, such as cold cathode fluorescent lamps. The backlight is driven by the inverter having the pulse driving circuit 200, and the lamps thereby illuminate the LCD panel. The pulse driving circuit 200 includes a pulse generator 210, a capacitor 220, an NMOS transistor 230, a current limiting resistor 240, a diode 250, a load circuit 260, and a twelve volt DC power supply 270. The pulse generator 210 can be a PWM IC, which is configured for generating a pulse signal. A width of the pulse signal generated by the pulse generator 210 is in the range from 05 volts. A frequency of the pulse signal generated by the pulse generator 210 is approximately equal to fifty-two thousand hertz. The load circuit 260 is a coil of a transformer.

A gate electrode “G” of the NMOS transistor 230 is connected to the pulse generator 210 via the capacitor 220. A drain electrode “D” of the NMOS transistor 230 is connected to the load electrode 260. A source electrode “S” of the NMOS transistor 230 is connected to the DC power supply 270.

The current limiting resistor 240 is connected between the gate electrode “G” and the source electrode “S” of the NMOS transistor 230. The positive terminal of the diode 250 is connected to the source electrode “S” of the NMOS transistor 230. The negative terminal of the diode 250 is connected to the gate electrode “G” of the NMOS transistor 230.

Operation of the pulse driving circuit 200 is as follows. When the LCD is turned on at the beginning, the twelve volt DC power supply 270 works and generates a steady twelve volts DC voltage when there is no pulse signal generated by the pulse generator 210. A potential of the gate electrode “G” of the NMOS transistor 230 is approximately equal to 11.3 volts. A voltage difference between the gate electrode “G” and the source electrode “S” is approximately equal to minus 0.7 volts. Thus the NMOS transistor 230 is turned off. The pulse driving circuit 200 is in an inactivate state.

When a plus five volts voltage generated by the pulse generator 210 is provided to the gate electrode “G” of the NMOS transistor 230 via the capacitor 220, a potential of the gate electrode “G” of the NMOS transistor 230 is increased to approximately 16.3 volts because of the characteristic of the capacitor 220. Thus a voltage difference between the gate electrode “G” and the source electrode “S” is approximately equal to plus 4.3 volts. Accordingly, the NMOS transistor 230 is turned on.

When a zero volts voltage generated by the pulse generator 210 is provided to the gate electrode “G” of the NMOS transistor 230 via the capacitor 220, a potential of the gate electrode “G” of the NMOS transistor 230 is decreased to approximately 11.3 volts from approximately 16.3 volts because of the characteristic of the capacitor 220. Thus a voltage difference between the gate electrode “G” and the source electrode “S” of the NMOS transistor 230 is approximately equal to minus 0.7 volts. Accordingly, the NMOS transistor 230 is turned off.

Because the frequency of the pulse signal generated by the pulse generator 210 is approximately equal to fifty-two thousand hertz, the DC power supply 270 drives the load circuit 260 via the NMOS transistor 230 with a switching frequency which is approximately equal to fifty-two thousand hertz. Thus an inverter (not shown) using the pulse driving circuit 200 can generate a high alternating current (AC) for driving the backlight of the LCD. The pulse driving circuit 200 only includes one NMOS transistor 230, thus the cost of the pulse driving circuit 200 is reduced.

Accordingly, an endurance voltage of the diode 250 is approximately equal to seventy-five volts. Supposing “R” represents a resistance of the current limiting resistor 240, and “C” represents a capacitance of the capacitor 220, the resistance “R” of the current limiting resistor 240 and the capacitance “C” of the capacitor 220 satisfy the following formula:

R·C=2 milliseconds (ms)

A preferred resistance “R” of the current limiting resistor 240 is approximately equal to 2 KΩ (kiloohms). A preferred capacitance of the capacitor 220 is equal to 1 μF (microfarads). Alternatively, when inner resistances of the DC power supply 270 and the pulse generator 210 are changed, the constant “2 milliseconds” in above formula can be adjusted to match up with the changed inner resistances of the DC power supply 270 and the pulse generator 210.

It is to be understood, however, that even though numerous characteristics and advantages of the preferred embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A pulse driving circuit comprising:
a pulse generator configured for generating a pulse signal for driving the pulse driving circuit;
a capacitor;
an NMOS (negative metal-oxide semiconductor) transistor comprising a gate electrode connected to the pulse generator via the capacitor, a drain electrode configured to be connected to a load circuit, and a source electrode configured to be connected to a DC (direct current) power supply;
a current limiting resistor connected between the gate electrode and the source electrode of the NMOS transistor; and
a diode comprising a positive terminal connected to the source electrode of the NMOS transistor and a negative terminal connected to the gate electrode of the NMOS transistor.

2. The pulse driving circuit as claimed in claim 1, further comprising a DC power supply connected to the source electrode of the NMOS transistor, wherein an output voltage of the DC power supply is approximately twelve volts.

3. The pulse driving circuit as claimed in claim 1, wherein a width of the pulse signal is in the range from 0˜5 volts.

4. The pulse driving circuit as claimed in claim 3, wherein a frequency of the pulse signal is approximately equal to fifty-two thousand hertz.

5. The pulse driving circuit as claimed in claim 1, wherein a resistance “R” of the current limiting resistor and a capacitance “C” of the capacitor satisfy the following formula:
R·C=2 milliseconds.

6. The pulse driving circuit as claimed in claim 5, wherein the resistance of the current limiting resistor is approximately equal to 2 KΩ.

7. The pulse driving circuit as claimed in claim 5, wherein the capacitance of the capacitor is approximately equal to 1 μF.

8. The pulse driving circuit as claimed in claim 1, wherein an endurance of the diode is approximately equal to seventy-five volts.

9. The pulse driving circuit as claimed in claim 1, wherein the pulse generator is a pulse width modulation integrated circuit.

10. The pulse driving circuit as claimed in claim 1, wherein the load circuit is a coil of a transformer.

11. A liquid crystal display (LCD) device comprising:
an LCD panel;
at least one backlight configured for illuminating the LCD panel; and
an inverter configured for driving the at least one backlight, the inverter comprising a pulse driving circuit, the pulse driving circuit comprising:
a pulse generator configured for generating a pulse signal for driving the pulse driving circuit;
a capacitor;
an NMOS (negative metal-oxide semiconductor) transistor comprising a gate electrode connected to the pulse generator via the capacitor, a drain electrode configured to be connected to a load circuit, and a source electrode configured to be connected to a DC (direct current) power supply;
a current limiting resistor connected between the gate electrode and the source electrode of the NMOS transistor; and
a diode comprising a positive terminal connected to the source electrode of the NMOS transistor and a negative terminal connected to the gate electrode of the NMOS transistor.

12. The LCD device as claimed in claim 11, further comprising a DC power supply connected to the source electrode of the NMOS transistor, wherein an output voltage of the DC power supply is approximately twelve volts.

13. The LCD device as claimed in claim 11, wherein a width of the pulse signal is in the range from 0˜5 volts.

14. The LCD device as claimed in claim 13, wherein a frequency of the pulse signal is approximately equal to fifty-two thousand hertz.

15. The LCD device as claimed in claim 11, wherein a resistance “R” of the current limiting resistor and a capacitance “C” of the capacitor satisfy the following formula:
R·C=2 milliseconds.

16. The LCD device as claimed in claim 15, wherein the resistance of the current limiting resistor is approximately equal to 2 KΩ.

17. The LCD device as claimed in claim 15, wherein the capacitance of the capacitor is approximately equal to 1 μF.

18. The LCD device as claimed in claim 11, wherein an endurance of the diode is approximately equal to seventy-five volts.

19. The LCD device as claimed in claim 11, wherein the pulse generator is a pulse width modulation integrated circuit.

20. The LCD device as claimed in claim 11, wherein the load circuit is a coil of a transformer.
